(19) United States
(12) Patent Application Publication
(10) Pub. No.: US 2015/0068503 A1
(43) Pub. Date: Mar. 12, 2015

(54) COMPRESSOR COVER WITH INTEGRATED EGR VALVE

(71) Applicant: GM Global Technology Operations LLC, Detroit, MI (US)

(72) Inventors: Ko-Jen Wu, Troy, MI (US); Jason C. Melecosky, Oxford, MI (US)

(73) Assignee: GM Global Technology Operations LLC, Detroit, MI (US)

(21) Appl. No.: 14/023,955

(22) Filed: Sep. 11, 2013

(51) Int. Cl. F02M 25/07

(52) U.S. Cl. CPC F02M 25/0772
USPC 123/568.21

(57) ABSTRACT

A compressor assembly pressurizes an airflow that is received from the ambient for delivery to an internal combustion engine having a cylinder block section and a cylinder head section. The cylinder head section is configured to supply an air-fuel mixture to the cylinder for combustion therein and exhaust post-combustion gases therefrom. The compressor assembly includes a compressor cover configured to receive the airflow from the ambient and a compressor wheel disposed inside the compressor cover and configured to pressurize the airflow. The compressor assembly also includes an exhaust gas recirculation (EGR) valve that is incorporated into the compressor cover and is in fluid communication with each of the cylinder head section and the compressor wheel. The EGR valve is configured to control delivery of the exhaust post-combustion gases from the cylinder head into the compressor cover. An internal combustion engine employing such a compressor assembly is also disclosed.

### TECHNICAL FIELD

The present disclosure relates to a compressor cover having an integrated EGR valve.

### BACKGROUND

In internal combustion engines (ICE), exhaust gas recirculation (EGR) is a nitrogen oxide (NOx) emissions reduction technique used in gasoline and diesel engines. EGR works by recirculating a portion of an engine's exhaust as an inert gas back to the engine's cylinders.

In a gasoline engine, this inert exhaust gas displaces some portion of combustible fuel-air mixture in the cylinder. In a diesel engine, the inert exhaust gas replaces some of the excess oxygen in pre-combustion fuel-air mixture. Because NOx forms primarily when a mixture of nitrogen and oxygen is subjected to high temperature, the lower combustion temperatures caused by EGR reduces the amount of NOx the combustion generates.

Frequently, such engines are also called upon to generate considerable levels of power for prolonged periods of time on a dependable basis while maintaining respectable fuel efficiency. To meet such demands, many gasoline and diesel engines employ a supercharging device, such as an exhaust gas turbine driven turbocharger, to compress the airflow before it enters the intake manifold of the engine.

Specifically, a turbocharger is a centrifugal gas compressor that forces more air and, thus, more oxygen into the combustion chambers of the ICE than is otherwise achievable with ambient atmospheric pressure. The additional mass of oxygen-containing air that is forced into the ICE improves the engine's volumetric efficiency, allowing it to burn more fuel in a given cycle, and thereby produce more power.

### SUMMARY

One embodiment of the disclosure is directed to a compressor assembly for pressurizing an airflow for delivery to an internal combustion engine having a cylinder block section and a cylinder head section. The cylinder head section is configured to supply an air-fuel mixture to the cylinder for combustion therein and exhaust post-combustion gases therefrom. The compressor assembly includes a compressor cover configured to receive the airflow from the ambient and a compressor wheel disposed inside the compressor cover and configured to pressurize the airflow. The compressor assembly also includes an exhaust gas recirculation (EGR) valve that is incorporated, i.e., structurally integrated, into the compressor cover and is in fluid communication with each of the cylinder head section and the compressor wheel. The EGR valve is configured to control delivery of the exhaust post-combustion gases from the cylinder head into the compressor cover.

The compressor cover may include an inlet for the airflow being received from the ambient and an outlet for the pressurized airflow. In such a case, the EGR valve may be incorporated at the inlet and configured to control reintroduction of the exhaust post-combustion gases into the airflow received from the ambient, i.e., the unpressurized airflow. Additionally, the compressor cover may include a fluid flow mixer arranged at the inlet. Accordingly, the fluid flow mixer may be configured to mix the exhaust post-combustion gases with the unpressurized airflow.

The compressor cover may include an inlet for the airflow being received from the ambient and an outlet for the pressurized airflow. In such a case, the EGR valve may be incorporated at the outlet and configured to control reintroduction of the exhaust post-combustion gases into the pressurized airflow. Additionally, the compressor cover may include a fluid flow mixer arranged at the outlet. Accordingly, the fluid flow mixer may be configured to mix the exhaust post-combustion gases with the pressurized airflow.

The compressor cover may include a coolant passage configured to route a coolant proximate to the EGR valve such that the coolant removes heat generated by the reintroduced exhaust post-combustion gases.

The EGR valve may be configured as one of a poppet-, butterfly-, and swing-type valve.

The compressor cover may include a sealable opening configured to provide a service access to the EGR valve.

The compressor cover may include a removable cover configured to selectively open and close the opening to control service access to the EGR valve.

Furthermore, the engine may include an electronic controller. In such a case, the EGR valve may be in electric communication with the controller, such that the EGR valve is regulated by the controller.

Another embodiment of the present disclosure is directed to an internal combustion engine having the compressor assembly as described above.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a top view of an engine with a compressor assembly having a compressor cover and an exhaust gas recirculation (EGR) valve incorporated into the compressor cover according to the disclosure.

FIG. 2 is a partial cross-sectional view of the compressor assembly shown in FIG. 1.

FIG. 3 is a close up perspective view of the compressor assembly shown in FIG. 1 showing the EGR valve incorporated at an inlet of the compressor cover according to an embodiment of the disclosure.

FIG. 4 is a close up perspective view of the compressor assembly shown in FIG. 1 showing the EGR valve incorporated at an outlet of the compressor cover according to another embodiment of the disclosure.

### DETAILED DESCRIPTION

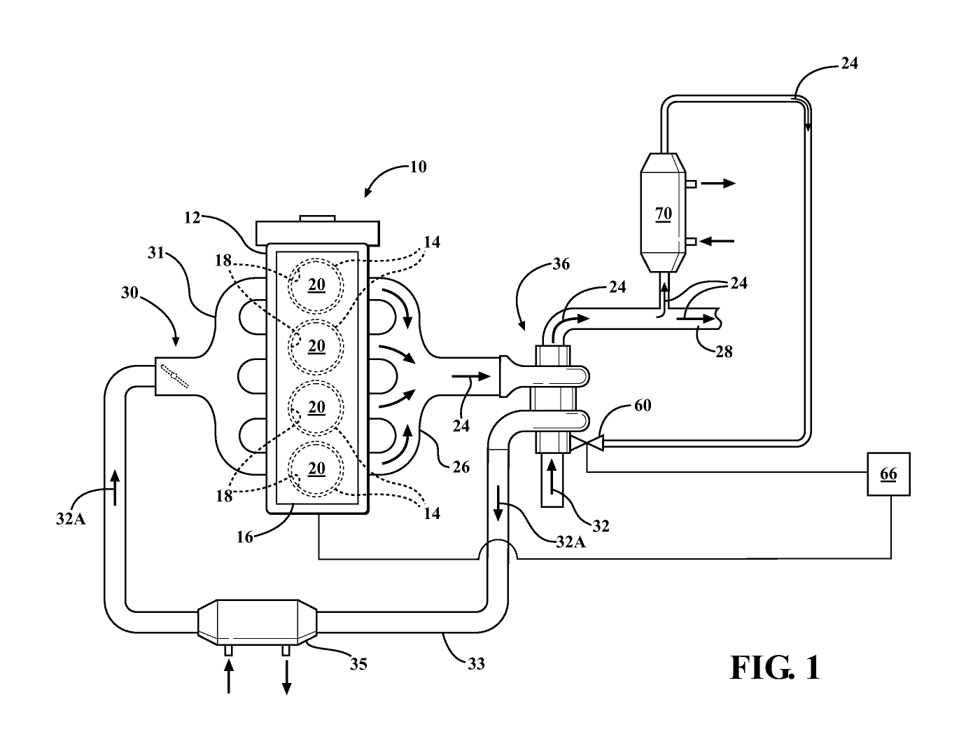

Referring to the drawings wherein like reference numbers correspond to like or similar components throughout the several figures, FIG. 1 illustrates an internal combustion (IC) engine 10. The engine 10 may be configured as either a spark-ignition (gasoline) or a compression-ignition (diesel) engine. The engine 10 also includes a cylinder block section 12 with a plurality of cylinders 14 arranged therein. The engine 10 also includes a cylinder head section 16. The cylinder head section 16 may be mounted to the cylinder block section 12 or be structurally integrated therewith. Each cylinder 14 includes a piston 18 configured to reciprocate therein. Combustion chambers 20 are formed within the cylinders 14 between the bottom surface of the cylinder head section 16 and the tops of the pistons 18. As known by those skilled in the art, each of the combustion chambers 20 receives fuel and air via the cylinder head section 16, wherein the fuel and air form a fuel-air mixture for subsequent combustion inside the subject combustion chamber. The cylinder head section 16 is also configured to exhaust post-combustion gases from the combustion chambers 20.

The engine 10 also includes a crankshaft 22 configured to rotate within the cylinder block section 12. The crankshaft 22 is rotated by the pistons 18 as a result of an appropriately proportioned fuel-air mixture being burned in the combustion chambers 20. After the air-fuel mixture is burned inside a specific combustion chamber 20, the reciprocating motion of a particular piston 18 serves to exhaust post-combustion gases 24 from the respective cylinder 14. From the cylinder 14, the post-combustion gases 24 are channeled via an exhaust manifold 26 to a compressor assembly 36 that will be described in detail below. After the compressor assembly 36, the post-combustion gases 24 are channeled via an exhaust passage 28.

The engine 10 additionally includes an induction system 30 configured to channel an airflow 32 from the ambient to the compressor assembly 36 and a pressurized airflow 32A from the compressor assembly to the cylinders 14. The induction system 30 includes an intake air duct 33, an intake manifold 31 for distributing the airflow between the cylinders 14, an intercooler 35 for reducing temperature of the pressurized airflow 32A, and the compressor assembly 36. Although not shown, the induction system 30 may additionally include an air filter upstream of the compressor assembly 36 for removing foreign particles and other airborne debris from the airflow 32. The compressor assembly 36 is configured to pressurize the airflow 32 received from the ambient, while the intake air duct 33 is configured to channel the pressurized airflow 32A from the compressor assembly 36 to the intake manifold 31 for delivery via the cylinder head section 16 to the respective cylinders 14. The intake manifold 31 additionally distributes the pressurized airflow 32A to the cylinders 14 for mixing with an appropriate amount of fuel and subsequent combustion of the resultant fuel-air mixture.

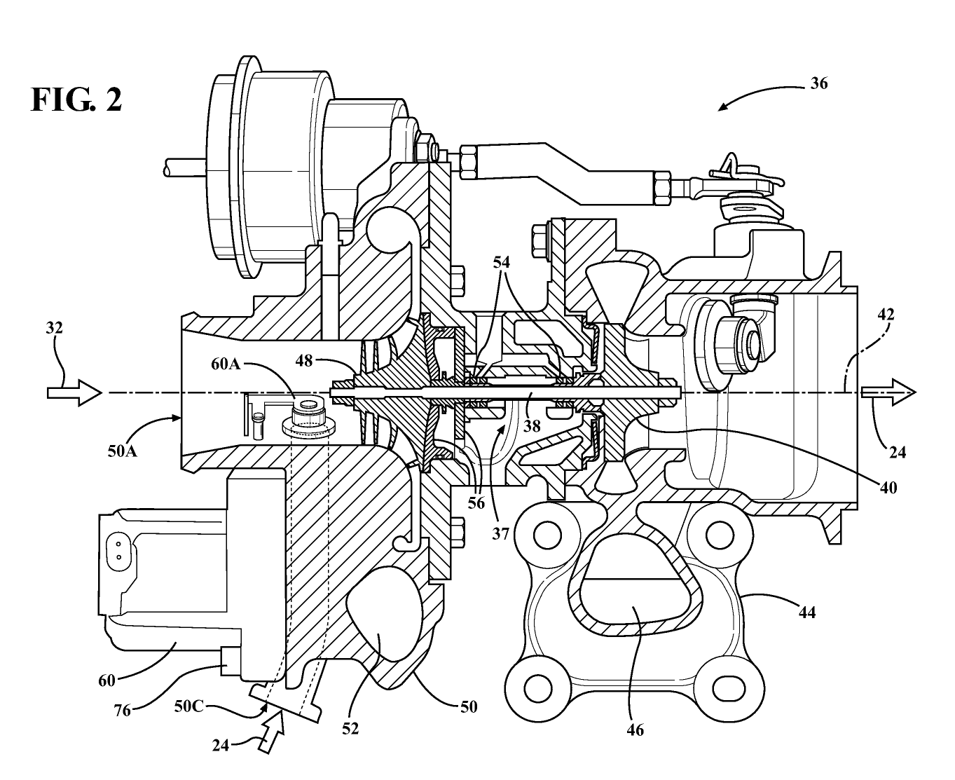

In the case of an exhaust driven compressor assembly (shown in FIG. 2), the compressor assembly 36 may include a rotating assembly 37. The rotating assembly includes a shaft 38 and a turbine wheel 40 mounted thereon. The turbine wheel 40 is configured to be rotated along with the shaft 38 about an axis 42 by the post-combustion gases 24 emitted from the cylinders 14. The turbine wheel 40 is typically formed from a temperature and oxidation resistant material, such as a nickel-chromium-based “inconel” super-alloy to reliably withstand temperatures of the post-combustion gases 24, which in some engines may approach 2,000 degrees Fahrenheit. The turbine wheel 40 is disposed inside a turbine housing 44 that includes a turbine volute or scroll 46. The turbine scroll 46 receives the post-combustion exhaust gases 24 and directs the exhaust gases to the turbine wheel 40. The turbine scroll 46 is typically formed from a high strength material, such as a cast iron, and configured to achieve specific performance characteristics, such as efficiency and response, of the compressor assembly 36.

The rotating assembly also includes a compressor wheel 48 that is mounted on the shaft 38. As the shaft 38 is rotated via the turbine wheel 40 by the post-combustion gases 24, the shaft imparts rotation to the compressor wheel 48. As a consequence, the rotating compressor wheel 48 pressurizes the airflow 32 being received from the ambient for eventual delivery to the cylinders 14. The compressor wheel 48 is disposed inside a compressor cover 50 that includes a compressor volute or scroll 52. The compressor scroll 52 receives unpressurized airflow 32 at an inlet 50A and directs the airflow to the compressor wheel 48 for pressurization. Pressurized airflow 32A is emitted from the compressor cover 50 aft of the compressor wheel 48 via an outlet 50B. The scroll 52 is configured to achieve specific performance characteristics, such as peak airflow and efficiency of the compressor assembly 36. As understood by those skilled in the art, the variable flow and force of the post-combustion exhaust gases 24 influences the amount of boost pressure that may be generated by the compressor wheel 48 throughout the operating range of the engine 10. The compressor wheel 48 is typically formed from a high-strength aluminum alloy that provides the compressor wheel with reduced rotating inertia and quicker spin-up response.

With continued reference to FIG. 2, the rotating assembly 37 is supported for rotation about the axis 42 via journal bearings 54 and also includes thrust bearings 56 configured to absorb thrust forces generated by the rotating assembly 37 as the compressor assembly 36 is pressurizing the airflow 32, to generate the pressurized airflow 32A. In addition to the compressor assembly 36 being configured as a conventional type that is driven by the post-combustion gases 24, a.k.a., a turbocharger, as described above, the compressor assembly may also be configured as an electrically driven unit. In the case of an electrically driven compressor assembly, in place of the turbine wheel 40, the rotating assembly 37 typically employs an actuator (not shown), such as an electric motor configured to drive the shaft 38. In the case of a conventional exhaust energy driven compressor assembly 36, the post-combustion gases 24 are routed to the compressor assembly to energize the rotating assembly 37 and also provide exhaust gas recirculation (EGR) by reintroducing the post-combustion gases into the airflow 32 prior to combustion. In the case of an electrically driven compressor assembly, the post-combustion gases 24 are not used to energize the compressor assembly, but are still routed to the compressor assembly to provide EGR.

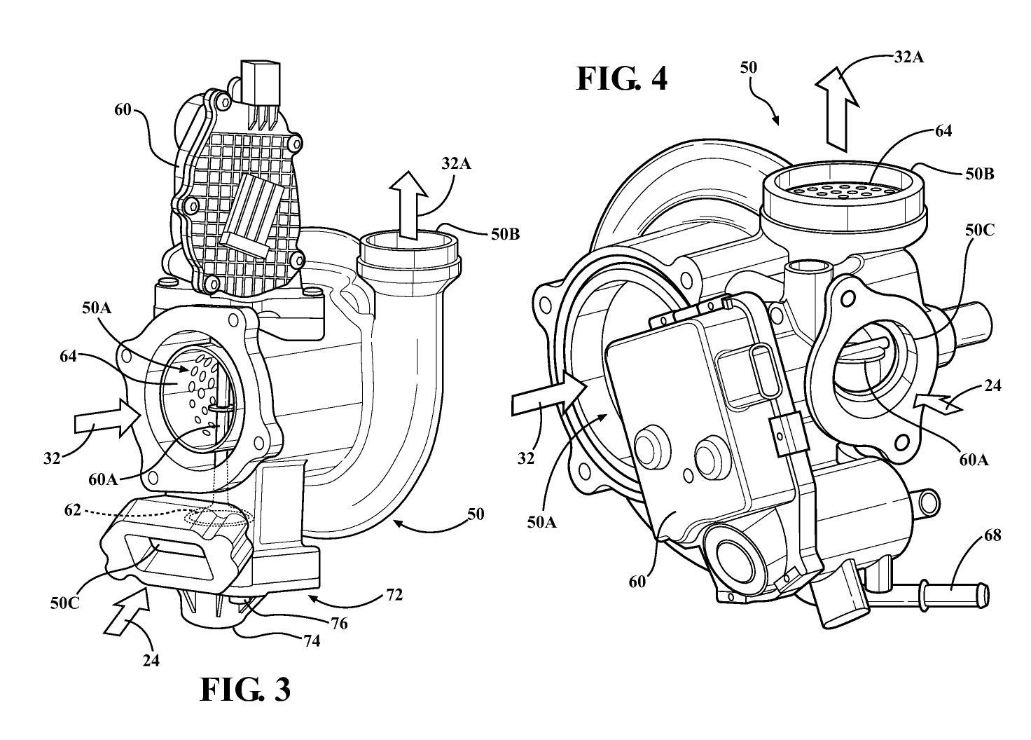

As shown in FIGS. 1-3, an EGR valve actuator 60 is incorporated, i.e., structurally integrated into the compressor cover 50. The EGR valve actuator 60 is configured to control operation of an EGR valve 60A. The EGR valve 60A is configured to variably restrict delivery of the post-combustion gases 24 from the cylinder head section into the compressor cover 50 via an EGR valve 60A at an EGR inlet 50C. Accordingly, the EGR valve 60A is in fluid communication with both, the cylinder head section 16 and the compressor wheel 48. Additionally, the compressor cover 50 defines a seat 62 (shown in FIG. 3) configured to accept and locate the EGR valve 60A with respect to the compressor wheel 48. The EGR valve 60A and the EGR inlet 50C may be positioned either upstream or downstream of the compressor wheel 48 such that the post-combustion gases 24 are directed from the cylinder head section 16 into the compressor cover 50 by being respectively mixed in with the unpressurized airflow 32 or pressurized airflow 32A. Accordingly, the EGR valve 60A may be incorporated at the inlet 50A to control reintroduction of the exhaust post-combustion gases 24 into the unpressurized airflow 32 (as shown in FIG. 3). In the alternative, the EGR valve 60A and the EGR inlet 50C may be incorporated at the outlet 50B to control reintroduction of the exhaust post-combustion gases 24 into the pressurized airflow 32A (as shown in FIG. 4).

As shown in FIGS. 3-4, the compressor cover 50 may also include a fluid flow mixer 64. The fluid flow mixer 64 is configured to mix the exhaust post-combustion gases 24 with the airflow 32. In the case where the EGR valve 60A is incorporated at the inlet 50A, the mixer 64 is arranged at the inlet 50A, downstream of the EGR valve (FIG. 3). On the other hand, in the case where the EGR valve 60A is incorporated at the outlet 50B, the mixer 64 is arranged proximately to and downstream of the EGR valve at the outlet 50B (FIG. 4). The engine 10 may additionally include an electronic controller 66. The controller 66 may be configured to control operation of the engine 10 and also programmed to regulate operation of the EGR valve 60A via the EGR valve actuator 60.

In general, atmospheric nitrogen begins to react with oxygen at elevated combustion temperatures, which can exceed 2500 degrees Fahrenheit. The result is emissions of various compounds called nitrogen oxides (NOx) as part of the exhaust stream. Generally, to reduce the formation of NOx, combustion temperatures are reduced to slow down the NOx formation kinetics. Typically, combustion temperatures are reduced below such a threshold by recirculating a small amount of post-combustion gases through the EGR valve. Typically, around 5-15% of the post-combustion gases in gasoline engines and up to 50% of the post-combustion gases in diesel engines is routed back to the combustion chambers as EGR. The EGR process may be used to reduce formation of NOx emissions in both gasoline and diesel engines.

In gasoline engines, use of EGR may additionally increase engine efficiency through such factors as reduction in throttling losses and reduced heat rejection. EGR dilutes the incoming air/fuel mixture and has a quenching effect on combustion temperatures which keeps NOx within acceptable limits. As an added benefit, EGR also reduces a gasoline engine's octane requirements, which lessens the danger of premature ignition and spark knock. Since the EGR system recirculates a portion of exhaust gases, in both gasoline and diesel engines, over time the EGR valve can become clogged with carbon deposits that may cause the valve to stick or prevent the valve from closing properly. However, a clogged EGR valve can be cleaned and returned to proper operation.

As shown, the compressor cover 50 may also include a coolant supply passage 68. The coolant supply passage 68 is configured to route a coolant proximate to the EGR valve 60A and near the seat 62 such that the coolant removes heat generated by the reintroduced exhaust post-combustion gases 24 from the compressor cover 50. Coolant flow within the coolant supply passage 68 may be provided by a fluid pump (not shown) that is also used to circulate coolant throughout the engine 10. Additionally, the coolant in the coolant supply passage 68 may be circulated through a dedicated radiator or cooler 70 (shown in FIG. 1) that is configured to reject heat that the coolant was able to remove from the compressor cover 50 near the seat 62.

The EGR valve 60A may be configured as one of a swing-, poppet-, and butterfly-type valve, shown in FIGS. 2, 3, and 4, respectively. As shown in FIG. 3, the compressor cover 50 may include a sealable opening 72 configured to provide a service access to the EGR valve 60A. The opening 72 is configured to facilitate removal of soot that may collect due to the flow of post-combustion gases 24. Such cleaning of the EGR valve 60A may be necessary to minimize possible sticking of the valve and restore proper operation thereof. The compressor cover 50 may also include a removable cover 74. The cover 74 may be configured to selectively open and close the opening 72 to control the service access to the EGR valve 60A. The cover 74 may be attached to the compressor cover 50 via appropriate fasteners 76 (shown in FIGS. 2 and 3).

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. An internal combustion engine comprising:
a cylinder block section defining a cylinder;
a reciprocating piston disposed inside the cylinder;
a cylinder head section operatively connected to the cylinder block section and configured to supply an air-fuel mixture to the cylinder for combustion therein and exhaust post-combustion gases therefrom; and
a compressor assembly configured to pressurize an airflow being received from the ambient for delivery to the cylinder, the compressor assembly including:
a compressor cover configured to receive the airflow from the ambient;
a compressor wheel disposed inside the compressor cover and configured to pressurize the airflow; and
an exhaust gas recirculation (EGR) valve incorporated into the compressor cover and in fluid communication with each of the cylinder head and the compressor wheel;
wherein the EGR valve is configured to control delivery of the exhaust post-combustion gases from the cylinder head into the compressor cover.

2. The engine of claim 1, wherein the compressor cover includes an inlet for the airflow being received from the ambient and an outlet for the pressurized airflow, and wherein the EGR valve is incorporated at the inlet and configured to control reintroduction of the exhaust post-combustion gases into the airflow received from the ambient.

3. The engine of claim 2, wherein the compressor cover includes a fluid flow mixer arranged at the inlet, and wherein the fluid flow mixer is configured to mix the exhaust post-combustion gases with the airflow received from the ambient.

4. The engine of claim 1, wherein the compressor cover includes an inlet for the airflow being received from the ambient and an outlet for the pressurized airflow, and wherein the EGR valve is incorporated at the outlet and configured to control reintroduction of the exhaust post-combustion gases into the pressurized airflow.

5. The engine of claim 4, wherein the compressor cover includes a fluid flow mixer arranged at the outlet, and wherein the fluid flow mixer is configured to mix the exhaust post-combustion gases with the pressurized airflow.

6. The engine of claim 1, wherein the compressor cover includes a coolant passage configured to route a coolant proximate to the EGR valve such that the coolant removes heat generated by the reintroduced exhaust post-combustion gases.

7. The engine of claim 1, wherein the EGR valve is configured as one of a poppet-, butterfly-, and swing-type valve.

8. The engine of claim 1, wherein the compressor cover includes a sealable opening configured to provide service access to the EGR valve.

9. The engine of claim 8, wherein the compressor cover includes a removable cover configured to selectively open and close the opening to control a service access to the EGR valve.

10. The engine of claim 1, further comprising an electronic controller configured to regulate operation of the EGR valve.

11. A compressor assembly for pressurizing an airflow that is received from the ambient for delivery to an internal combustion engine having a cylinder head section and a cylinder block section that is operatively connected to the cylinder block section and defines a cylinder, wherein the cylinder head is configured to supply an air-fuel mixture to the cylinder for combustion therein and exhaust post-combustion gases therefrom, the compressor assembly comprising:
a compressor cover configured to receive the airflow from the ambient;
a compressor wheel disposed inside the compressor cover and configured to pressurize the airflow; and
an exhaust gas recirculation (EGR) valve incorporated into the compressor cover and in fluid communication with each of the cylinder head and the compressor wheel;
wherein the EGR valve is configured to control delivery of the exhaust post-combustion gases from the cylinder head into the compressor cover.

12. The compressor assembly of claim 11, wherein the compressor cover includes an inlet for the airflow being received from the ambient and an outlet for the pressurized airflow, and wherein the EGR valve is incorporated at the inlet and configured to control reintroduction of the exhaust post-combustion gases into the airflow received from the ambient.

13. The compressor assembly of claim 12, wherein the compressor cover includes a fluid flow mixer arranged at the inlet, and wherein the fluid flow mixer is configured to mix the exhaust post-combustion gases with the airflow received from the ambient.

14. The compressor assembly of claim 11, wherein the compressor cover includes an inlet for the airflow being received from the ambient and an outlet for the pressurized airflow, and wherein the EGR valve is incorporated at the outlet and configured to control reintroduction of the exhaust post-combustion gases into the pressurized airflow.

15. The compressor assembly of claim 14, wherein the compressor cover includes a fluid flow mixer arranged at the outlet, and wherein the fluid flow mixer is configured to mix the exhaust post-combustion gases with the pressurized airflow.

16. The compressor assembly of claim 11, wherein the compressor cover includes a coolant passage configured to route a coolant proximate to the EGR valve such that the coolant removes heat generated by the reintroduced exhaust post-combustion gases.

17. The compressor assembly of claim 11, wherein the EGR valve is configured as one of a poppet-, butterfly-, and swing-type valve.

18. The compressor assembly of claim 11, wherein the compressor cover includes a sealable opening configured to provide service access to the EGR valve.

19. The compressor assembly of claim 18, wherein the compressor cover includes a removable cover configured to selectively open and close the opening to control a service access to the EGR valve.

20. The compressor assembly of claim 11, wherein:
the engine includes an electronic controller;
the EGR valve is in electric communication with the controller; and
the EGR valve is regulated by the controller.
